(19) United States
(12) Patent Application Publication
(10) Pub. No.: US 2012/0144214 A1
(43) Pub. Date: Jun. 7, 2012

(54) OPTICAL NETWORK UNIT, POWER SOURCE EQUIPMENT AND POWER SUPPLY SYSTEM USING THE SAME

(75) Inventors: Eun-Gu LEE, Daejeon-si (KR); Jeong-Gook KWON, Daejeon-si (KR); Kyu-Ouk LEE, Daejeon-si (KR); Seung-Hyun CHO, Daejeon-si (KR); Sang-Soo LEE, Daejeon-si (KR)

(73) Assignee: Electronics and Telecommunications Research Institute, Daejeon-si (KR)

(21) Appl. No.: 13/308,194

(22) Filed: Nov. 30, 2011

(30) Foreign Application Priority Data
Dec. 1, 2010 (KR) 10-2010-0121254

(51) Int. Cl. G06F 1/26

(52) U.S. Cl. 713/300

(57) ABSTRACT

An optical network unit is provided that includes a communication detector configured to detect whether a communication is achieved between the ONU and at least one power source equipment (PSE), and a power controller configured to detect whether the PSE is powered and to control electrical power, which is provided from the PSE, based on at least one of the detection result about whether the communication is achieved between the ONU and the PSE and the detection result about the PSE is powered.

### CROSS-REFERENCE TO RELATED APPLICATION

This application claims the benefit under 35 U.S.C. §119(a) of Korean Patent Application No. 10-2010-0121254, filed on Dec. 1, 2010, the disclosure of which is incorporated by reference in its entirety for all purposes.

### BACKGROUND

1. Field

The following description relates to an optical network unit capable of receiving electrical power from a power source equipment (PSE) using a power over ethernet (POE).

2. Description of the Related Art

A Fiber To the Home (FTTH) technology involves transmitting or receiving data from a central office (CO) to a customer home by use of an optical cable. For example, the FTTH technology may include Active Optical Network (AON) and Passive Optical Network (PON).

According to the PON, an optical signal transmitted from the CO into customers is diverged by use of a passive optical device, which does not use electrical power, such as a Remote Node (RN) or a splitter, and transmits the diverged optical signal to a subscriber. Such a PON technology includes Time Division Multiplexing (TDM) scheme and Wavelength Division Multiplexing (WDM) scheme. According to TDM-PON, channels are divided based on time. According to WDM-PON, channels are divided based on wavelengths.

In order to communicate with a customer terminal unit of WDM-PON or TDM-PON, a photoelectric converter is required in converting optical signals to electrical signals. The photoelectric converter is divided into an optical network unit (ONU) and an optical network terminal (ONT) based on its installation place, in which the ONU is installed outside of a house and the OLT is installed inside of a house. The OLT, installed inside of a house, is easily supplied with electrical power. However, since the ONU is installed outside of a house, additional power supply equipment needs to be provided. Accordingly, if the ONU is installed in a small-medium size building or an outworn building where power supply equipment is not provided, it is hard to supply the ONU with electrical power. In this regard, there is a need for a study to effectively supply the ONU with electrical power.

### SUMMARY

In one aspect, there is provided a technology in which an optical network unit (ONU) receives electrical power from at least one power source equipment for supplying electrical power.

In another general aspect, there is provided a an optical network unit (ONU) including: a is communication detector configured to detect whether a communication is achieved between the ONU and at least one power source equipment (PSE); and a power controller configured to detect whether the PSE is powered and to control electrical power, which is provided from the PSE, based on at least one of the detection result about whether the communication is achieved between the ONU and the PSE and the detection result about the PSE is powered. The power controller may receive electrical power from the PSE if the PSE is powered and the communication is achieved between the ONU and the PSE.

The power controller may block electrical power supplied from the PSE to the ONU and changes an operation mode of the PSE into a sleep mode allowing the PSE to only have electrical power required for initiating a communication of the PSE if the PSE is powered and the communication is not achieved between the ONU and the PSE.

If a communication is achieved between the ONU and the PSE in a state that the PSE operates in a sleep mode allowing the PSE to only have electrical power required for initiating a communication of the PSE, the power controller may cancel asleep mode of the PSE and receives electrical power from the PSE.

The power controller may receive electrical power from an exclusive power supply connector of the PSE if electrical power supplied from the PSE is insufficient.

The power controller may receive electrical power equally from each of the at least one of PSEs if the at least one of PSEs exist.

The ONU may further include a power supplier configured to supply electrical power delivered from the power controller to a passive optical network (PON) media access control (MAC).

The ONU may further include a connector configured to connect the power controller to the PSE. The connector may be an RJ-45.

The ONU may further include a control signal input module which resides inside or is outside of the ONU and generates a control signal to control an operation of the power controller, wherein the power controller controls the electrical power supplied from the PSE according to the control signal.

In another general aspect, there is provided a power source equipment (PSE) including: a connector configured to connect an optical network unit (ONU) to the PSE; and a power supplier configured to supply the ONU with electrical power, which is delivered from external power source, through the connector.

The PSE may further include a data processor configured to transmit data, which is received through the connector, to a terminal or transmit data, which is received from the terminal, to the ONU through the connector.

The connector may include a connector, which is configured to provide the ONU with electrical power and data, and an exclusive power supply connector which is configured to provide the ONU with only electrical power. The connector may be an RJ-45.

In another general aspect, there is provided a power supply system comprising a power source equipment including: a power source equipment comprising a connector configured to connect an optical network unit (ONU) to the power source equipment and a power supplier configured to provide the ONU with electrical power, which is provided from an external power source, through the connector; and an optical network unit comprising a communication detector configured to detect whether a communication is achieved between the ONU and at least one vi power source equipment (PSE), and a power controller configured to detect whether the PSE is powered and to control electrical power, which is provided from the PSE, based on at least one of the detection result about whether the communication is achieved between the ONU and the at least one of PSE and the detection result about the at least one of PSE is powered.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating an example of a power supply system.

FIG. 2 is a diagram illustrating an example of an optical network unit (ONU).

FIGS. 3 to 5 are diagrams illustrating an example of controlling electrical power in the ONU of FIG. 2.

FIG. 6 is a diagram illustrating an example of power source equipment (PSE).

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, examples will be described with reference to accompanying drawings in detail.

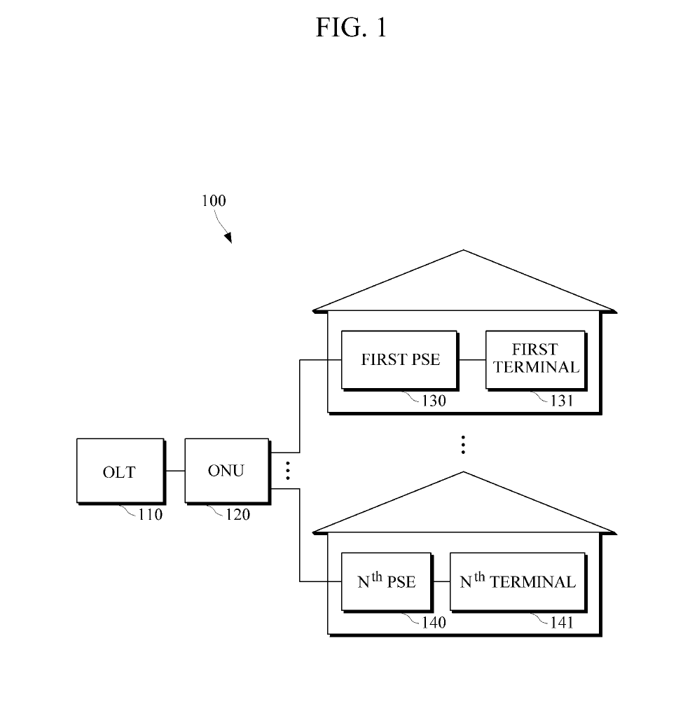

FIG. 1 is a diagram illustrating an example of a power supply system.

Referring to FIG. 1, a power supply system 100 includes an optical line termination (OLT) 110, an optical network unit (ONU) 120, a first power source equipment (PSE) 130, an n^{th} power source equipment (PSE) 140, a first terminal 131 and an n^{th} terminal 141. The power supply system 100 may include a plurality of PSEs and a plurality of terminals.

The OLT 110 is a part of a Fiber To the Home (FTTH) and represents an endpoint of a service provider network. For example, the OLT 110 is a multiservice providing device configured to FTTH to another system and may be formed using a stable image platform program (SIPP) apparatus, a cable television apparatus, a transmission apparatus and a network management apparatus. The OLT 110 may reside between a user and a service node. The OLT 110 may be connected to the ONU 120 through an optical cable.

The ONU 120 may transmit data, which is input from the OLT 110, to a plurality of PSE 130 and 140.

The ONU 120 may include a communication detector (not shown) and a power controller (not shown). The communication detector is configured to detect whether a communication is achieved between the ONU 120 and at least one PSE. The power controller (not shown) is configured to detect whether the PSEs 130 and 140 are powered and to control electrical power, which is provided from the PSE, based on at least one of based on the detection result about whether the communication is achieved between the ONU and the detection result about the at least one PSE is powered.

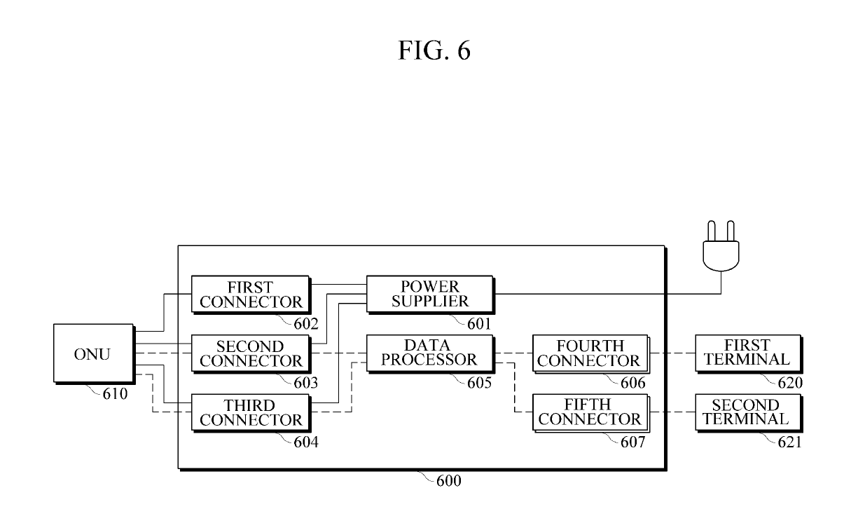

The first PSE 130 and the n^{th} PSE 140 may supply the ONU 120 with electrical power, which has been supplied from an external power source. In addition, the first PSE 130 and the n^{th} PSE 140 transmit data, which is received from the ONU 120, to the terminals 131 and 141. Alternatively, the first PSE 130 and the n^{th} PSE transmit data, which is received from the terminals 131 and 141, to the ONU 120. The detailed description thereof will be made later in relation to FIG. 6.

The first terminal 131 and the n^{th} terminal 141 may be implemented using a camera, a is computer and an internet protocol (IP) telephone.

Since the ONU 120 receives electrical power from at least one PSE, even if the ONU is installed at a place having a difficulty in receiving electrical power, a stable power supply is ensured.

In addition, since the ONU 120 receives electrical power from at least one PSE, even if one of the at least one PSE does not operate, the ONU is powered by remaining PSE.

Electrical power provided from the PSE is controlled based on a detection result about whether the PSE performs communication and a detection result about whether the PSE is powered, thereby preventing the electrical power from being wasted.

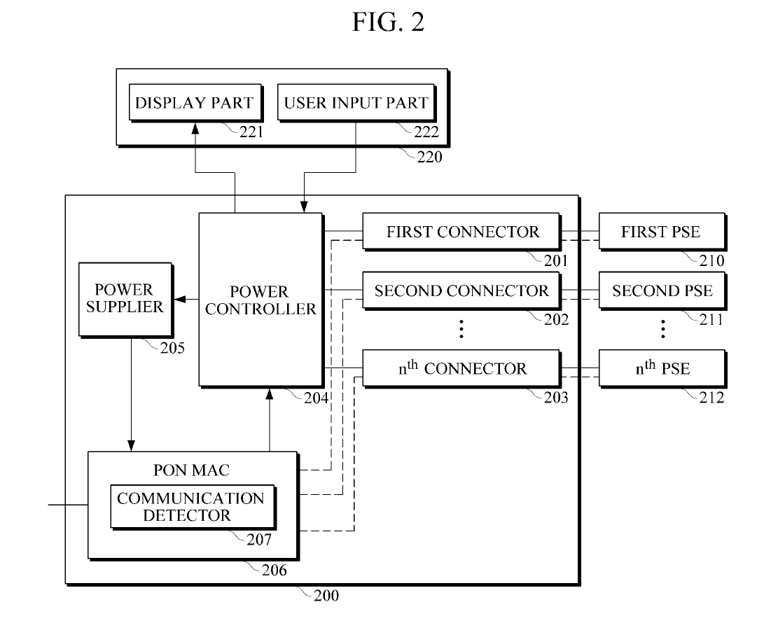

FIG. 2 is a diagram illustrating an example of an optical network unit (ONU).

As shown in FIG. 2, an ONU 200 includes connectors 201, 202 and 203, a power controller 204, a power supplier 205 and a passive optical network (PON) media access controller (MAC) system 206. The ONU 200 may further include a control signal input module 220. The control signal input module 220 may reside inside or outside of the ONU 200. The PON MAC system 206 may include a communication detector 207.

The connectors 201, 202 and 203 are connected to PSEs 210, 211 and 212, respectively. For example, the connector may be formed using an RJ-45. The connectors 201, 202 and 203 may transmit electrical power, which is received from the PSEs 210, 211 and 212, to the power controller 204. The connectors 201, 202 and 203 may transmit data, which is received from the PSEs 210, 211 and 212, to the communication detector 207. In FIG. 2, the transmission and reception of electrical power is represented using a solid line, and the transmission and reception of data is represented using a dotted line.

The power controller 204 transmits electrical power, which is provided from at least one of the PSEs 210, 211 and 212, to the power supplier 205.

The power controller 204 may detect whether the PSEs 210, 211 and 212 are powered. For example, the power controller 204 may detect whether the PSEs 210, 211 and 212 are powered, based on the connection of the PSE with a power source.

The communication detector 207 detects whether a communication is achieved among the ONU and the PSEs. For example, the communication detector 207 may detect whether a communication is achieved among the ONU and the PSEs, based on data reception through the connectors 201, 202 and 203. The communication detector 207 transmits a detection result about a communication to the power controller 204.

The power controller 204 controls electrical power, which is provided from the PSEs 210, 211 and 212, based on at least one of the detection result about whether the communication is achieved between the ONU and the PSE and the detection result about the at least one PSE is powered.

For example, the power controller 204 may extract at least one of the PSEs 210, 211 and 212 which is powered and makes a communication with the ONU. The power controller 204 may receive electrical power from the extracted PSEs. In this case, the power controller 204 may receive electrical power equally from each of the PSEs.

For example, the power controller 204 extracts one of the PSEs 210, 211 and 212 which is powered and does not make a communication with the ONU. The power controller 204 blocks electrical power supplied from the extracted PSE to the ONU and changes an operation mode of the extracted PSE into a sleep mode that allows the extracted PSE to only have electrical power required when the extracted PSE initiates a communication. For example, the power controller 204 may generate a control signal to change an operation mode of the extracted PSE into a sleep mode and transmit the generated control signal to the extracted PSE. As a result, the extracted PSE changes its operation mode into a sleep mode according to the control signal. In this manner, the extracted PSE receives a minimum amount of electrical power that is required for initiation of a communication, thereby preventing unnecessary power consumption. The PSE may have various operation modes in addition to a sleep mode.

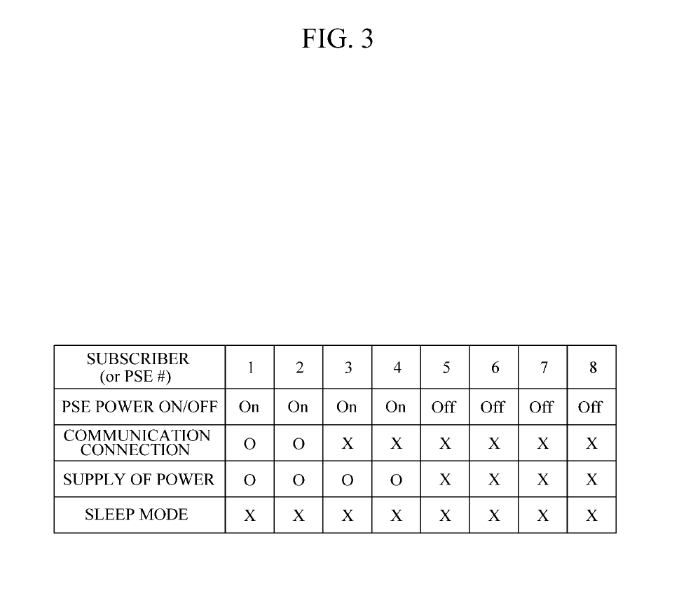

For example, the power controller 240 may extract one of the PSEs 210, 211 and 212 which is in a sleep mode where the PSE has a predetermined amount of electrical power required for initiation of a communication. At this time, if a communication is achieved between the ONU and the extracted PSE, the power controller 204 cancels the sleep mode of the extracted PSE to receive electrical power from the extracted PSE. Detailed description thereof will be made later with reference to FIGS. 3, 4 and 5.

The power supplier 205 may provide electrical power, which is received from the power controller 204, to a component requiring electrical power. For example, the power supplier 205 may provide the PON MAC system 206 with the electrical power that is received from the power controller 204.

The control signal input module 220 is configured to input a control signal used to control an operation of the power controller 204. The control signal input module 220 may include a display part 221 and a user input part 222.

The control signal input module 220 may reside inside or outside of the ONU 200. If the control signal input module 220 reside outside of the ONU 200, the ONU 200 may be connected to the control signal input module 220 through a wired network or a wireless network. The control signal input module 220 may be included in an element management system (EMS) server. Although not shown in drawings, each of the ONU 200 and the control signal input module 220 may include a communication module to perform a communication.

The power controller 204 may send the control signal input module 220 detection information, which is obtained by the communication detector 207, and detection information about whether the PSE is powered.

The display part 221 may display the detection information, which is obtained by the communication detector 207, and the detection information about whether the PSE is powered. For example, the display part 221 may display a User Interface (UI) or a Graphic User Interface (GUI) that is related to the detection information, which is obtained by the communication detector 207, and the detection information about whether the PSE is powered.

The display part 221 may include at least one of a liquid crystal display (LCD), a thin film transistor-liquid crystal display (TFT-LCD), an organic light-emitting diode (OLED), a flexible display and a 3-D display.

A user may recognize the detection information, which is obtained by the communication detector 207, and the detection information about whether the PSE is powered through the display part 221. The user may generate a control signal based on the detection information, which is being displayed on the display part 221, by use of the user input part 222. The generated control signal may be transmitted to the power controller 204.

The user input part 222 is configured to generate a control signal that is used by a user to control an operation of the power controller 204. The user input part 222 may include a key pad, a dome switch, a touch pad (capacitive type or resistive type), a jog wheel and a jog switch.

The power controller 204 may control electrical power, which is supplied from the PSEs 210, 211 and 212, according to the control signal that is received from the control signal input module 220.

As described above, since the ONU receives electrical power from at least one PSE, even if the ONU is installed at a place having a difficulty in receiving electrical power, a stable power supply is ensured.

FIGS. 3 to 5 are diagram illustrating an example of controlling electrical power in the ONU of FIG. 2.

Hereinafter, the description will be made on the assumption that the number of PSEs is is eight.

As shown in FIGS. 2 and 3, a first PSE, a second PSE, a third PSE and a fourth PSE are powered, and a fifth PSE, a sixth PSE, a seventh PSE and an eighth PSE are not powered. In addition, a communication of an ONU with respect to the first PSE and the second PSE is achieved, and a communication of the ONU with respect to the third PSE and the fourth PSE is not achieved. The ONU receives electrical power from the first, second, third and fourth PSEs other than the fifth, sixth, seventh and eighth PSEs.

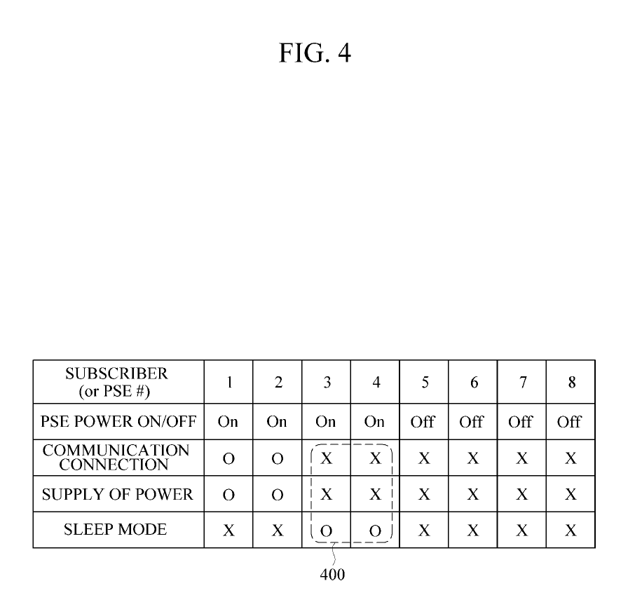

As shown in FIG. 4, since a communication of the ONU with respect to the third PSE and the fourth PSE is not achieved, the power controller 204 of the ONU blocks electrical power supplied from the third PSE and the fourth PSE to the ONU and changes an operation mode of each of the third PSE and the fourth PSE into a sleep mode such that the third PSE and the fourth PSE only have electrical power that is required for initiating their communication (400).

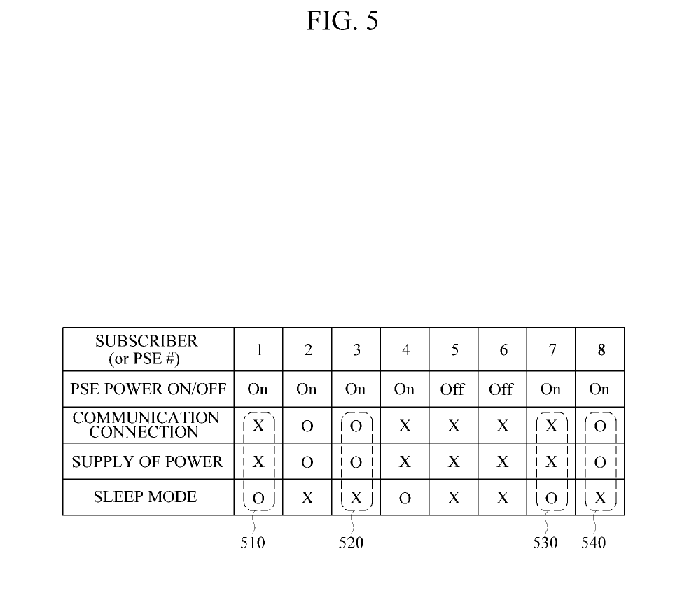

As shown in FIG. 5, if a communication between the ONU and the first PSE ends, the power controller 204 blocks electrical power supplied from the first PSE to the ONU and changes an operation mode of the firth PSE into a sleep mode (510). If a communication is initiated again between the ONU and the third PSE in a state that the third PSE operates in the sleep mode, the power controller 204 cancels the sleep mode of the third PSE and receives electrical power from the third PSE (520). If the seventh PSE is powered and a communication between the ONU and the seventh PSE is not achieved, the power controller 204 changes an operation mode of the seventh PSE into a sleep mode (530). If the eighth PSE is powered and a communication between the ONU and the eighth PSE is achieved, the power controller 204 receives electrical power from the eighth PSE (540). As shown in FIG. 5, the power controller 204 receives electrical power from the second, third and eighth PSEs. For example, the power controller 204 may receive electrical power equally from each of the second, third and eight PSEs.

FIG. 6 is a diagram illustrating an example of power source equipment (PSE).

As shown in FIG. 6, the PSE 600 includes connectors, including a first connector 602, a second connector 603, a third connector 604, a fourth connector 606 and a fifth connector 607, a power supplier 601 and a data processor 605.

The first connector 602, the second connector 603 and the third connector 604 are configured to connect the power supplier 601 and the data processor 605 to an ONU 610.

The first connector 602 transmits electrical power received from the power supplier 601 to the ONU 610. The first connector 602 transmits only electrical power other than data. The first connector 602 is an exclusive power supply connector.

The second and third connectors 602 and 604 transmit electrical power received from the power supplier 601 to the ONU 610. In addition, the second and third connectors 602 and 604 may transmit data received from the data processor 605 to the ONU 610.

The fourth connector 606 transmits data received from the data processor 605 to a first terminal 620.

The fifth connector 607 transmits data received from the data processor 605 to a second terminal 621. For example, the connector may be implemented using an RJ-45.

The power supplier 601 provides the ONU 610 with electrical power, which is received from an external power source, through the connectors 602, 603 and 604.

The data processor 605 may transmit data, which is received from the ONU 610, to the first and second terminals 620 and 621, or transmit data, which is received from the first and second terminals 620 and 621, to the ONU 610. For example, the data processor may transmit data, which is received from the second connector 603 and the third connector 604, to the first terminal 620 and the second terminal 621 through the fourth connector 606 and the fifth is connector 607. For example, the data processor may transmit data, which is received from the fourth connector 606 and the fifth connector 607, to the ONU 610 through the second connector 603 and the third connector 604. In FIG. 6, the transmission and reception of electrical power is represented using a solid line and the transmission and reception of data is represented using a dotted line.

The ONU 610 may further receive electrical power through the first connector 602, if electrical power supplied through the second connector 603 and the third connector 604 is insufficient. Accordingly, the ONU 610 stably receives electrical power.

As described above, since the ONU receives electrical power from at least one power source equipment, even if the ONU is installed at a place having a difficulty in receiving electrical power, a stable power supply is ensured.

Since the ONU receives electrical power from at least one power source equipment, even if one of the at least one power source equipment does not operate, the ONU is powered by remaining power source equipment.

Electrical power provided from the power source equipment is controlled based on a detection results about the PSE performs communication and the PSE is powered, thereby preventing the electrical power from being wasted.

The disclosure can also be embodied as computer readable codes on a computer readable recording medium or as carrier wave. The computer readable recording medium is any data storage device that can store data which can be thereafter read by a computer system. The carrier wave may represent transmission through Internet.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so is that the computer readable code is stored and executed in a distributed fashion

Also, functional programs, codes, and code segments for accomplishing the present invention can be easily construed by programmers skilled in the art to which the present invention pertains. A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical network unit (ONU) comprising:
a communication detector configured to detect whether a communication is achieved between the ONU and at least one power source equipment (PSE); and
a power controller configured to detect whether the PSE is powered and to control electrical power, which is provided from the PSE, based on at least one of the detection result about whether the communication is achieved between the ONU and the PSE and the detection result about the PSE is powered.

2. The ONU of claim 1, wherein the power controller receives electrical power from the PSE if the PSE is powered and the communication is achieved between the ONU and the PSE.

3. The ONU of claim 1, wherein the power controller blocks electrical power supplied from the PSE to the ONU and changes an operation mode of the PSE into a sleep mode allowing the PSE to only have electrical power required for initiating a communication of the PSE if the PSE is powered and the communication is not achieved between the ONU and the PSE.

4. The ONU of claim 1, wherein if a communication is achieved between the ONU and the PSE in a state that the PSE operates in a sleep mode allowing the PSE to only have electrical power required for initiating a communication of the PSE, the power controller cancels asleep mode of the PSE and receives electrical power from the PSE.

5. The ONU of claim 1, wherein the power controller receives electrical power from an exclusive power supply connector of the PSE if electrical power supplied from the PSE is insufficient.

6. The ONU of claim 1, wherein the power controller receives electrical power equally from each of the at least one of PSEs if the at least one of PSEs exist.

7. The ONU of claim 1, further comprising a power supplier configured to supply electrical power delivered from the power controller to a passive optical network (PON) media access control (MAC).

8. The ONU of claim 1, further comprising a connector configured to connect the power controller to the PSE.

9. The ONU of claim 8, wherein the connector is an RJ-45.

10. The ONU of claim 1, further comprising a control signal input module which resides inside or outside of the ONU and generates a control signal to control an operation of the power controller,
wherein the power controller controls the electrical power supplied from the PSE according to the control signal.

11. A power source equipment (PSE) comprising:
a connector configured to connect an optical network unit (ONU) to the PSE; and
a power supplier configured to supply the ONU with electrical power, which is delivered from external power source, through the connector.

12. The PSE of claim 11, further comprising a data processor configured to transmit data, which is received through the connector, to a terminal or transmit data, which is received from the terminal, to the ONU through the connector.

13. The PSE of claim 11, wherein the connector comprises a connector, which is configured to provide the ONU with electrical power and data, and an exclusive power supply connector which is configured to provide the ONU with only electrical power.

14. The PSE of claim 11, wherein the connector is an RJ-45.

15. A power supply system comprising a power source equipment comprising:
is a power source equipment comprising a connector configured to connect an optical network unit (ONU) to the power source equipment and a power supplier configured to provide the ONU with electrical power, which is provided from an external power source, through the connector; and
an optical network unit comprising a communication detector configured to detect whether a communication is achieved between the ONU and at least one power source equipment (PSE), and a power controller configured to detect whether the PSE is powered and to control electrical power, which is provided from the PSE, based on at least one of the detection result about whether the communication is achieved between the ONU and the at least one of PSE and the detection result about the at least one of PSE is powered.
